(19) United States
(12) Patent Application Publication
(10) Pub. No.: US 2020/0273586 A1
(43) Pub. Date: Aug. 27, 2020

(54) INTERNET OF THINGS DEVICE, SERVER FOR SECURITY OF THE INTERNET OF THINGS DEVICE, AND METHOD FOR SECURITY OF THE INTERNET OF THINGS DEVICE

(71) Applicant: ELECTRONICS AND TELECOMMUNICATIONS RESEARCH INSTITUTE, Daejeon (KR)

(72) Inventors: Yun Kyung LEE, Daejeon (KR); Kyeong Tae KIM, Daejeon (KR); Jeong Nyeo KIM, Daejeon (KR); Seon Gyoung SOHN, Daejeon (KR); Jae Deok LIM, Sejong-si (KR)

(21) Appl. No.: 16/798,730

(22) Filed: Feb. 24, 2020

(30) Foreign Application Priority Data
Feb. 26, 2019 (KR) 10-2019-0022784
Feb. 7, 2020 (KR) 10-2020-0014684

(51) Int. Cl. G16Y 30/10; G16Y 40/50; H04L 9/08; H04N 21/2347

(52) U.S. Cl. CPC G16Y 30/10; H04N 21/2347; H04L 9/0825; G16Y 40/50

(57) ABSTRACT

A method for security of an Internet of things (IoT) device includes transmitting, by a server, a key value determined based on a reliability level of a user device and a key identification (ID) of the key value to the user device, encrypting, by the user device, a command representing a service requested by a user by using the key value and transmitting the encrypted command and the key ID to the IoT device, and extracting, by the IoT device, the key value corresponding to the key ID received from the user device from pre-stored key list information, decrypting the encrypted command by using the extracted key value, executing the decrypted command to generate information requested by the user, encrypting the generated information by using the extracted key value, and transmitting the encrypted information to the user device.

### CROSS-REFERENCE TO RELATED APPLICATIONS

This application claims priority under 35 U.S.C. § 119 to Korean Patent Application No. 10-2019-0022784 filed on Feb. 26, 2019 and Korean Patent Application No. 10-2020-0014684 filed on Feb. 7, 2020, the disclosure of which is incorporated herein by reference in its entirety.

### BACKGROUND

### 1. Technical Field

The present invention relates to technology relevant to security of Internet of things (IoT).

### 2. Description of Related Art

IoT devices such as Internet protocol (IP) cameras are recently installed in each home, for monitoring a state and pets of each home and detecting intrusion of an unauthorized person.

If an unauthorized person having a malicious intention knows an IP and an identification/password (ID/PW) of an IP camera device, the unauthorized person may easily access an IoT device and may leak pieces of information, provided by the IoT device, to the outside. In this case, invasion of privacy may occur.

### SUMMARY

Accordingly, the present invention provides a security system and a method of enhancing security thereof, in which an escrow server for providing an interface between a user device and an IoT device (for example, an IP camera device) performs a primary authentication process on the user device, and only when the user device succeeding in authentication has an access authority, a key value enabling a request of information (for example, a request of an image) and device control (for example, camera control) is provided to the IoT device (for example, the IP camera device), thereby enhancing security of the IoT device.

Additional objects, features, and advantages of the present invention can be more clearly understood from the following detailed description and the accompanying drawings.

In one general aspect, a method for security of an Internet of things (IoT) device includes: transmitting, by a server, a key value determined based on a reliability level of a user device and a key identification (ID) of the key value to the user device; encrypting, by the user device, a command representing a service requested by a user by using the key value and transmitting the encrypted command and the key ID to the IoT device; and extracting, by the IoT device, the key value corresponding to the key ID received from the user device from pre-stored key list information, decrypting the encrypted command by using the extracted key value, executing the decrypted command to generate information requested by the user, encrypting the generated information by using the extracted key value, and transmitting the encrypted information to the user device.

In another general aspect, a server for security of an Internet of things (IoT) device includes: a processor configured to generate a key value determined based on a reliability level of a user device and a key identification (ID) of the key value; and a communication unit configured to, based on control by the processor, transmit the key value and the key ID to the user device so that the user device encrypts a command representing a service requested by a user by using the key value and the key ID each determined based on a reliability level thereof and transmits the encrypted command to the IoT device.

In another general aspect, an Internet of things (IoT) device includes: a communication unit configured to receive a command, encrypted by using a key value determined based on a reliability level of a user device, and a key identification (ID) of the key value from the user device; a storage medium configured to store key list information about where a plurality of key IDs are respectively connected to a plurality of key values; and a processor configured to extract the key value, connected to the key ID received through the communication unit, from the key list information, decrypt the encrypted command by using the extracted key value, execute the decrypted command to generate information, encrypt the generated information by using the extracted key value, and transmit the encrypted information to the user device through the communication unit.

Other features and aspects will be apparent from the following detailed description, the drawings, and the claims.

### BRIEF DESCRIPTION OF THE DRAWINGS

FIG. 1 is a signal flowchart illustrating a communication procedure between a user device and an IP camera device in the related art.

FIG. 2 is a signal flowchart illustrating a communication procedure for preventing the information leakage of an IoT device according to an embodiment of the present invention.

FIG. 3 is a diagram illustrating key information generated by an escrow server and transferred to an IP camera device, according to an embodiment of the present invention.

FIG. 4 is a signal flowchart illustrating a communication procedure performed prior to the communication procedure shown in the signal flowchart of FIG. 2.

FIG. 5 is a diagram for describing a small key update method among key update methods according to an embodiment of the present invention.

FIG. 6 is a block diagram illustrating an internal configuration of a user device according to an embodiment of the present invention.

FIG. 7 is a block diagram illustrating an internal configuration of an IoT device according to an embodiment of the present invention.

FIG. 8 is a block diagram illustrating an internal configuration of an escrow server according to an embodiment of the present invention.

### DETAILED DESCRIPTION OF EMBODIMENTS

Since the present invention may have diverse modified embodiments, preferred embodiments are illustrated in the drawings and are described in the detailed description of the present invention. However, this does not limit the present invention within specific embodiments and it should be understood that the present invention covers all the modifications, equivalents, and replacements within the idea and technical scope of the present invention.

In the following description, the technical terms are used only for explain a specific exemplary embodiment while not limiting the present invention. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

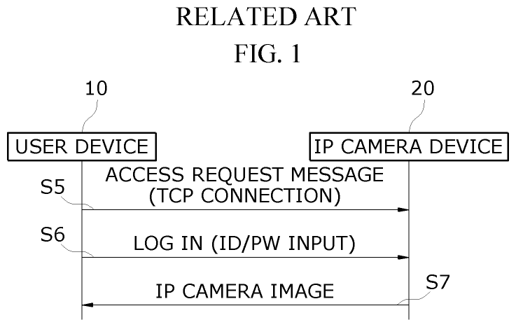

FIG. 1 is a signal flowchart illustrating a communication procedure between a general user device and an IoT device.

Referring to FIG. 1, an IoT device may be, for example, an IP camera device. However, an IoT device capable of being applied to the present invention is not limited to an IP camera device.

A user device 10 and an IP camera device 20 are not limited and may have a communication function so as to transmit and receive data on the basis of transmission control protocol (TCP) communication.

The user device 10 may be a computing device having a communication function, and the computing device may be, for example, a smartphone.

The IP camera device 20 may be a computing device having a communication function. However, a computing device based on the IP camera device 20 may further include an IP camera having a photographing function. On the other hand, the IP camera device 20 may be a desktop computer connected to an IP camera.

First, in S5, the user device 10 may transmit an access request message to the IP camera device 20 so as to access the IP camera device 20.

When the user device 10 receives a response message corresponding to an access request message from the IP camera device 20, a communication connection (a TCP connection) between the user device 10 and the IP camera 20 may be constructed based on an IP address of the IP camera device 20 included in the response message.

Subsequently, in S6, when the communication connection between the user device 10 and the IP camera 20 is constructed, a log-in screen may be displayed on a display screen of the user device 10.

When a user inputs an ID and a PW through an ID input window and a PW input window each included in the log-in screen, the user device 10 may generate log-in information including the ID and PW of the user and may transmit the log-in information to the IP camera device 20. The IP camera device 20 may perform an authentication procedure on the log-in information received from the user device 10.

Subsequently, in S7, when authentication of the user device 10 succeeds, the IP camera device 20 may transmit an IP camera image to the user device 10.

In this manner, in a general communication procedure between the user device 10 and the IP camera device 20, when the user of the user device 10 knows IP information about the IP camera and an ID/PW of the IP camera, the user may control the IP camera device 20 at a remote position by using the user device 10 and may be provided with an IP camera image obtained by the IP camera device 20.

Most users may use an initially set ID/PW, for accessing an IP camera device at a remote position, but since the initially set ID/PW is used without being periodically changed, the initially set ID/PW may be vulnerable to security.

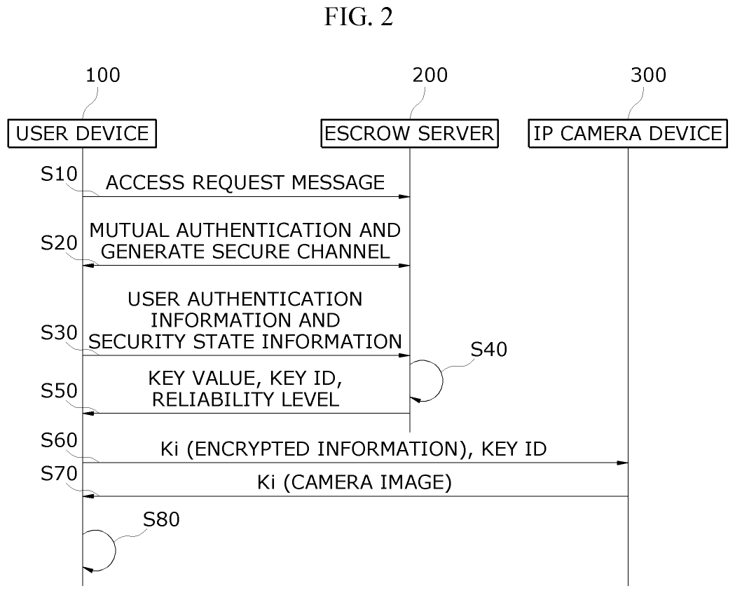

FIG. 2 is a signal flowchart illustrating a communication procedure based on a security system for an IoT device according to an embodiment of the present invention.

Referring to FIG. 2, the security system for an IoT device according to an embodiment of the present invention may include a user device 100, an IoT device 300, and an escrow server 200 for providing an interface between the user device 100 and the IoT device 300.

The user device 100 according to an embodiment of the present invention may have a difference with the communication procedure illustrated in FIG. 1 in that the user device 100 accesses the IoT device 300 by using the escrow server 200. Hereinafter, the IoT device 300 may be assumed to be an IP camera device.

First, in S10, the user device 100 may transmit an access request message, requesting an access to the IP camera device 300, to the escrow server 200. The access request message may include device information for identifying the user device 100 and device information (for example, an IP address of the IP camera device 300) for identifying the IP camera device 300.

Subsequently, in S20, when the escrow server 200 receives the access request message from the user device 100, a mutual authentication procedure between the user device 100 and the escrow server 200 may be performed.

When mutual authentication succeeds based on the mutual authentication procedure, a secure channel between the user device 100 and the escrow server 200 may be generated. Here, the secure channel may include, for example, a secure socket layer (SSL) channel, a transport layer security (TLS) channel, or a channel including the channels.

The mutual authentication procedure may be a device authentication procedure. The device authentication procedure may be a procedure of checking whether device information about the user device 100 and device information about the IP camera device 300, included in the access request message received by the escrow server 200 from the user device 100, are previously registered information.

Subsequently, in S30, when a secure channel is generated, the user device 100 may transmit user authentication information and security state information to the escrow server 200 by using the generated secure channel.

The user authentication information may include an ID and a PW of the user.

The security state information may include information representing a security state (or a security level) of the user device 100.

The security state information may be, for example, information representing whether an operating system (OS) installed in the user device 100 is updated to a latest version or a latest security patch is installed therein.

The security state information may be, for example, version information about the OS, version information about the security patch, or information including the information.

In the present embodiment, it is described that the user device 100 individually separates the user authentication information and the security state information and transmit the user authentication information and the security state information to the escrow server 200, but the user device 100 may not separate the user authentication information and the security state information and transmit one piece of information, including the user authentication information and the security state information, to the escrow server 200. In this case, the user authentication information may include the security state information. On the other hand, the security state information may include the user authentication information.

Subsequently, in S40, the escrow server 200 may perform a user authentication procedure on the basis of the user authentication information received from the user device 100, and subsequently or simultaneously, may analyze the security state information received from the user device 100 to verify a security state of the user device 100. The escrow server 200 may determine a reliability level of the user device 200 on the basis of a result obtained by verifying the security state of the user device 100.

When user authentication succeeds and verification of a security state is completed, the escrow server 200 may generate a key value Ki assigned to the user device 100 and a key ID of the key value Ki. The user device 100 and the IP camera device 300 may perform communication on the basis of the key value Ki and the key ID of the key value Ki.

The escrow server 200 may assign different key values Ki to the user device 100 on the basis of a reliability level of the user or/and a reliability level of the user device 100. The kind of a service available by the user may be changed based on the kind of the assigned key value Ki.

For example, an example of a service based on the reliability level of a user terminal 130 may be shown in the following Table 1.

TABLE 1

| | | Key value | |
|---|---|---|---|
| Reliability | Device | transmitted to | Example of |
| level | state | user device | available service |
| Level 1 | In unregistered | K₁ | Provide only three- |
| | user device, state | | minute view of |
| | where only user | | real-time camera |
| | authentication is | | image information |
| | completed | | |
| Level 2 | In registered user | K₂ | Provide real-time |
| | terminal, state | | camera image |
| | where security of | | information view |
| | minimum level is | | (time is not |
| | satisfied | | limited) |
| Level 3 | In registered user | K₃ | Camera control, |
| | terminal, state | | provide real-time |
| | where security is | | camera image |
| | high | | information view, |
| | | | and provide |
| | | | previous camera |
| | | | image information |
| | | | view |

In Table 1, the level 1 may represent a case where user authentication succeeds although device authentication fails. Here, device authentication failure may represent a case where a user is registered in the escrow server 200 but the user device 100 of the user is not registered.

In Table 1, the level 2 may represent a case where device authentication and user authentication succeed but a version of an OS or/and a version of a security patch in the user device 100 is/are an old version.

In Table 1, the level 3 may represent a case where device authentication and user authentication succeed but the version of the OS or/and the version of the security patch in the user device 100 is/are a latest version. Camera control in services provided in the level 3 may include the zoom-in/zoom-out control and tilt control (camera rotation control) of the IP camera device 300.

Subsequently, in S50, the escrow server 200 may transmit the key value Ki generated in S40 and a key ID thereof through a secure channel generated in S20.

Moreover, the escrow server 200 may a reliability level of the user device 100 and may additionally transmit the determined reliability level to the user device 100.

The user device 100 may provide the user with kinds of services available by the user through the display screen of the user device 100 on the basis of the reliability level received from the escrow server 200. The user may select the kind of a service, which is to be used, from among the kinds of services which are available by the user and are displayed on the display screen of the user device 100.

Subsequently, in S60, the user device 100 may encrypt user authentication information (including an ID and a PW), security state information, and command information representing the kind of the service to be used by the user by using the key value Ki received from the escrow server 200 and may transmit, to the IP camera device 300, the encrypted information (including the user authentication information, the security state information, and the command information) and a key ID of the key value Ki used for the encryption.

The command information may be information representing the kind of the service to be used by the user. For example, the command information may include at least one of a service for requesting a real-time camera image, a service for requesting a previous camera image, and a service for requesting camera control (the zoom-in/zoom-out control and camera rotation control of the IP camera device 300).

The IP camera device 300 may select a key value Ki, corresponding to the key ID received from the user device 100, from among keys received from the escrow server 200 and may decrypt the encrypted information (including the encrypted user authentication information, the encrypted security state information, and the encrypted command information) received from the user device 100 by using the selected key value Ki. Also, the IP camera device 300 may detect the user authentication information, the security state information, and the command information from the encrypted information on the basis thereof.

When the detection is completed, the IP camera device 300 may execute a command included in the detected command information. At this time, the execution of the command may be limited based on the reliability level of the user device 100 based on the detected user authentication information or/and the detected security state information.

For example, the user device 100 may issue, to the IP camera device 300, a request to execute a command requesting camera control, a command requesting a real-time camera image, and a command requesting a previous camera image, but when the reliability level of the user device 100 based on the detected security state information corresponds to the level 2, the IP camera device 300 may execute only the command requesting a real-time camera image and may not execute the other commands.

When decryption of the encrypted information by the IP camera device 300 fails, the IP camera device 300 may not know a command requested by the user, and thus, may generate an error message representing that it is unable to execute a corresponding command and may transmit the error message to the user device 100.

Subsequently, in S70, the IP camera device 300 may encrypt information (for example, a camera image), generated by executing the command requested by the user device 100, on the basis of the key value Ki and may transmit the encrypted information to the user device 100.

The information encrypted by the IP camera device 300 may include at least one of a real-time camera image captured for a limited time, a real-time camera image captured without time being limited, a previous camera image captured for a limited time, a real-time camera image obtained through photographing without time being limited, and a real-time camera image captured based on a camera control command of the user.

Subsequently, in S80, the user device 100 may receive the information encrypted by the IP camera device 300 and may decrypt the information encrypted by the IP camera device 300 by using the key value Ki.

The user device 100 may extract a camera image from the information encrypted by the IP camera device 300 on the basis of a decryption process and may display the extracted camera image on the display screen of the user device 100.

In this manner, in an embodiment of the present invention, the escrow server 200 may determine a reliability level on the basis of a result of user authentication and a result obtained by verifying a security state of the user device 100 and may assign key information (a key value Ki) and a key ID, each corresponding to the determined reliability level, to the user (or the user device 100) in S40.

Therefore, when the security state of the user device 100 is optimal, the escrow server 200 may assign a highest-level service (for example, a control authority on a zoom-in/zoom-out and tilt function of the IP camera device 300) to the user device 100, and when the security state of the user device 100 is low, the escrow server 200 may provide only a 30-second image or 3-minute image streaming service.

The escrow server 200 according to an embodiment of the present invention may provide the user device 100 and the IP camera device 300 with the key value Ki and the key ID, which are determined to provide a differential service on the basis of the security state of the user device 100, and the user device 100 and the IP camera device 300 may transmit and receive information by using the key value Ki and the key ID, thereby considerably improving the security of the camera device 300.

Although not clearly illustrated in FIG. 2, the IP camera device 300 may perform a process of previously receiving key information from the escrow server 200, and in this case, the key information generated by the escrow server 200 and transmitted to the IP camera device 300 may include three pieces of information including user IDs (User1 and User 2), key IDs (key ID 1 to key IDn and key IDm+1 to key IDm+n), and key values (Ki: key1 to keyn and keym+1 to keym+n).

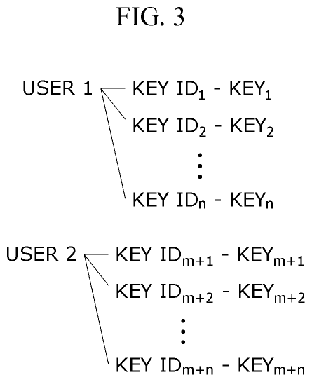

Referring to FIG. 3, a user ID, a key ID, and a key value Ki may be bound. When the user transmits encrypted information and an encrypted key ID to the IP camera device 300, the IP camera device 300 may decrypt encrypted data by using a key value Ki corresponding to a key ID and may extract a user ID from decrypted data to check whether a corresponding key ID is assigned to a key value Ki assigned to a corresponding user, thereby more enhancing security.

When a processing performance and a storage space of an IoT device such as the IP camera device 300 are insufficient, the IP camera device 300 may be configured to store a [key ID (key ID)—key value (Ki)] pair instead of a [user ID (user ID)—key ID (key ID)—key value (Ki)] pair, and thus, the prevent embodiment may be applied to an IoT device which is insufficient in storage space and processing performance thereof.

In a case where an IoT device stores only the [key ID (key ID)—key value (Ki)] pair, a process of checking a relationship between a user ID (user ID) and a key ID (key ID) may not be performed, and thus, security may be reduced.

On the other hand, the IP camera device 300 may still provide the user device with differential information according to a reliability level of the user, based on the [key ID (key ID)—key value (Ki)] pair provided by the escrow server 200. Accordingly, the security of the IP camera device 300 may not largely be reduced.

When the IP camera device 300 is an IoT device where a possessor is clear like insulin pump, the IP camera device 300 may store only the [key ID (key ID)—key value (Ki)] pair and may encrypt/decrypt data.

The following Table 2 may be a table showing an example where an IoT device (for example, a personalized key like insulin pump) insufficient in storage space and processing performance stores a key.

TABLE 2

| | | Reliability | |
|---|---|---|---|
| Key ID | Key | level | Provided service |
| Key ID1 | 12345adbe | Level 1 | SID1, SID2 |
| Key ID2 | 6789ddef | Level 2 | SID1, SID2, SID3, |
| | | | SID4, SID5 |

The following Table 3 may be a table showing an example where an IoT device sufficient in resource (storage space and processing performance) stores a key.

TABLE 3

| User | Key | | Reliability | |
|---|---|---|---|---|
| ID | ID | Key value | level | Provided service |
| User1 | Key | adbe12345 | Level 1 | SID1, SID2 |
| | ID1 | | | |
| User1 | Key | ddef6789 | Level 2 | SID1, SID2, SID3, |
| | ID2 | | | SID4, SID5 |
| User2 | Key | abc459871 | Level 1 | SID1, SID2 |
| | ID3 | | | |
| User2 | Key | 78561111ab | Level 2 | SID1, SID2, SID3 |
| | ID4 | | | |

A key ID may be managed by the escrow server 200. The key ID managed by the escrow server 200 should satisfy uniqueness, and a key generated by the escrow server 200 should be randomly generated so that a hacker cannot analogize the key.

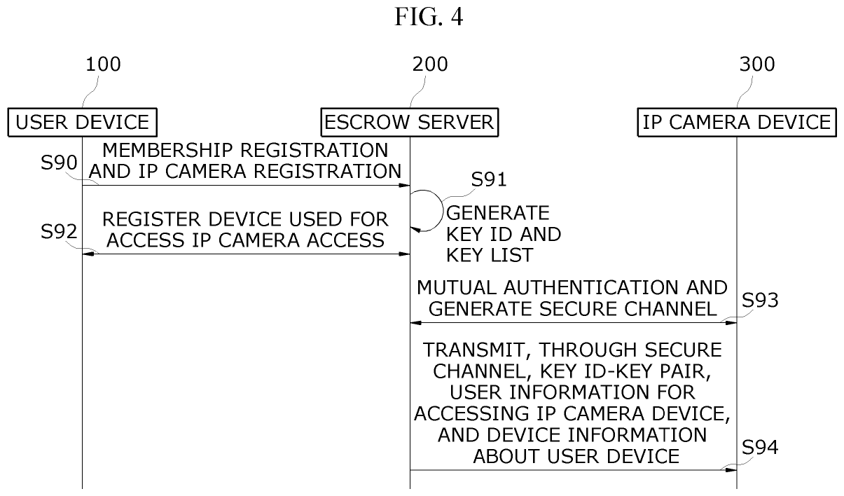

FIG. 4 is a signal flowchart illustrating a communication procedure performed prior to the communication procedure shown in the signal flowchart of FIG. 2.

Referring to FIG. 4, the user may purchase the IP camera device 300.

Subsequently, in S90, by using the user device 100, the user may access the escrow server 200 and may transmit membership registration information to the escrow server 200. The escrow server 200 may store the membership registration information, received from the user device 100, in a database to complete registration of the user in the user device.

The membership registration information may include user information (including a name, an address, a phone number, an ID, and a PW) and device information about an IP camera device purchased by the user, and the device information about the IP camera device may include an IP address, the kind of an IP camera, and an IP camera serial number.

Subsequently, in S91, the escrow server 200 may generate key list information including a key value (Ki)-key ID pair which is to be used to encrypt data in a communication process between the user device 100 and the IP camera device 300.

Subsequently, in S92, by using the user device 100, the user may register pieces of device information which is to be used when accessing the IP camera device 300.

Subsequently, in S93, the escrow server 200 may access the IP camera device 300 and may generate mutual authentication and a secure channel between the escrow server 200 and the IP camera device 300.

Subsequently, in S94, the escrow server 200 may transmit the key list information, including the key value (Ki)-key ID pair which is to be used to encrypt the data in the communication process between the user device 100 and the IP camera device 300, to the IP camera device 300 by using the generated secure channel. Also, the may transmit device information and user information for accessing a corresponding IP camera along with the key list information.

The key value Ki and the key ID each transmitted from the escrow server 200 to the IP camera device 300 may be periodically updated based on a security policy of the escrow server 200. Therefore, when the user device 100 stores previous key information (including a key value Ki and a key ID) despite having an access authority on the IP camera device 300, it may be impossible to access the IP camera device 300, and thus, various information provided by the IP camera device may be prevented from being leaked.

In a case where the escrow server 200 updates a key value Ki and a key ID, the escrow server 200 may access the IP camera device 300 to generate a secure channel and may transmit an updated key value Ki and key ID.

A method of updating a key value Ki and a key ID in the escrow server 200 may include a total key update method and a small key update method. In order to decrease a load of a key update, the total key update method and the small key update method may be used in common.

The total key update method may update all key-key ID pairs.

The small key update method may correct only a connection relationship between a key ID and key values (Ki: key₁ to keyₙ) each stored in the IP camera device 300.

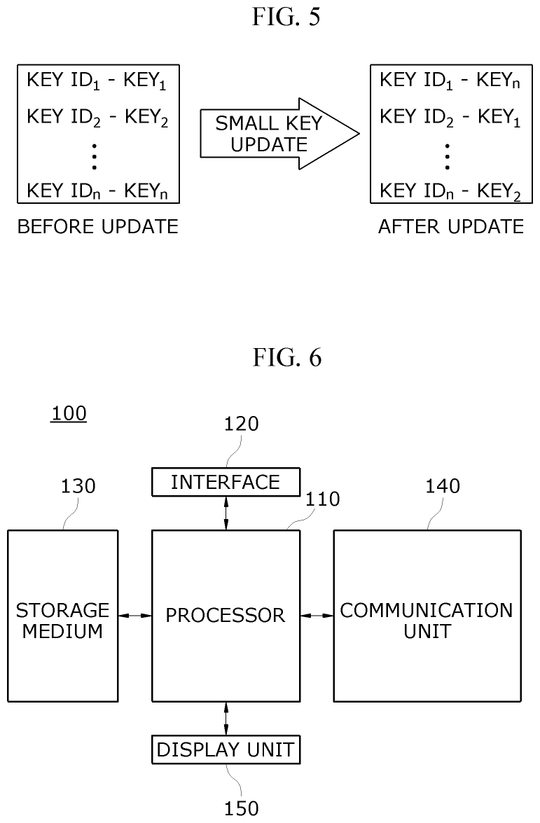

FIG. 5 is a diagram for describing the small key update method among key update methods according to an embodiment of the present invention.

Referring to FIG. 5, when a connection relationship where a key ID₁ is connected to a key₁, a key ID₂ is connected to a key₂, and a key IDₙ is connected to a keyₙ is updated based on the small key update method, only the connection relationship may be corrected based on a method where the key ID₁ is connected to the keyₙ, the key ID₂ is connected to the key₁, and the key IDₙ is connected to the key₂.

In the security method of an IoT device according to an embodiment of the present invention, when a user device includes previous key information or is low in a security state of the user device despite having an access authority on an IoT device (for example, an IP camera, insulin pump, or the like), the user device may be impossible to access the IoT device (for example, an IP camera, insulin pump, or the like) or may use only a limited service, thereby fundamentally solving a problem where personal information about a user is leaked to the outside.

Moreover, in the security method of an IoT device according to an embodiment of the present invention, different keys may be assigned based on an access authority of a user and a security state of a user device, and an IoT device may limit the kinds of services to be provided, based on the assigned keys.

In other words, all kinds of services may be provided to a reliable user device, and a limited service (for example, a 30-second image streaming service) may be provided to an unreliable user device.

Moreover, in the security method of an IoT device according to an embodiment of the present invention, since an escrow server periodically updates key information used to encrypt/decrypt data in a communication process between a user device and an IoT device, the user device may maintain high security even without changing an initially set ID and PW, for accessing the IoT device.

Moreover, although a user periodically changes an ID/PW of an IP camera, an escrow server may periodically update a key which is to be used between the user and the IP camera in an escrow server, thereby enhancing security.

Moreover, when an IP camera does not know a key value Ki, the IP camera may not respond to any message, and thus, the IP camera may not be hacked by a method of installing an arbitrary program in the IP camera.

The present embodiment may be applied to most IoT devices which are installed and are not continuously managed (a continuous access, changing of an ID/PW, etc.), in addition to an IP camera device, and thus, a service or information provided by an IoT device may be prevented from being leaked, thereby protecting assets of persons and companies as well as protecting privacy.

FIG. 6 is a block diagram illustrating an internal configuration of a user device 100 according to an embodiment of the present invention.

Referring to FIG. 6, the user device 100 may be a computing device. The computing device may be a user terminal, a desktop computer, or the like. The user terminal may be, for example, a smartphone.

The user device 100 may include a processor 110, an interface 120, a memory 130, a communication unit 140, and a display unit 150.

The processor 110 may control operations of the peripheral elements 120 to 150.

Moreover, the processor 110 may have a data processing function and may perform an encryption/decryption process on data, a communication message, and information each transmitted and received through the communication unit 140 on the basis of the data processing function. For example, the processor 110 may perform a processing process of encrypting user authentication information, security state information, and command information by using a key received from an escrow server 200. Also, the processor 110 may perform a processing process of decrypting encrypted information received from an IoT device.

Moreover, the processor 110 may process intermediate data or resultant data generated by one of the peripheral elements 120 to 150 to generate processed data and may transfer the generated data to one other element.

In order to control data processing and operations of the peripheral elements 120 to 150, the processor 110 may be implemented as a controller, an arithmetic logic unit (ALU), a digital signal processor, a microcomputer, a field programmable gate array (FPGA), a programmable logic unit (PLU), a microprocessor, or a hardware module for executing and responding to an instruction.

The interface 120 may provide an interface between a user and the processor 110 on the basis of control by the processor 110. The interface 120 may be implemented as, for example, a keyboard, a touch pad, a touch panel, or a key input device.

The storage medium 130 may include a volatile storage medium and a non-volatile storage medium. The storage medium 130 may be implemented as, for example, a volatile memory, a non-volatile memory, a hard disk, or the like.

The storage medium 130 may store various information transmitted from an IoT device. When the IoT device is an IP camera device, the storage medium 130 may temporarily or permanently store a camera image transmitted from the IP camera device.

Moreover, the storage medium 130 may temporarily or permanently store key information including a key value Ki and a key ID each received from the escrow server 200.

The communication unit 140 may support wireless communication between the escrow server 200 and an IoT device (for example, an IP camera device 300) on the basis of control by the processor 110. The wireless communication may include wireless Internet communication, mobile communication (for example, 3G, 4G, and 5G communications), etc. In order to support the wireless communication, the communication unit 140 may include a plurality of hardware modules having a modulation function, a demodulation function, a filtering function, and an amplification function.

The display unit 150 may display a camera image received from an IoT device through the communication unit 140 on the basis of control by the processor 110. The display unit 150 may be implemented as a liquid crystal display (LCD), an organic light emitting display (OLED), or the like.

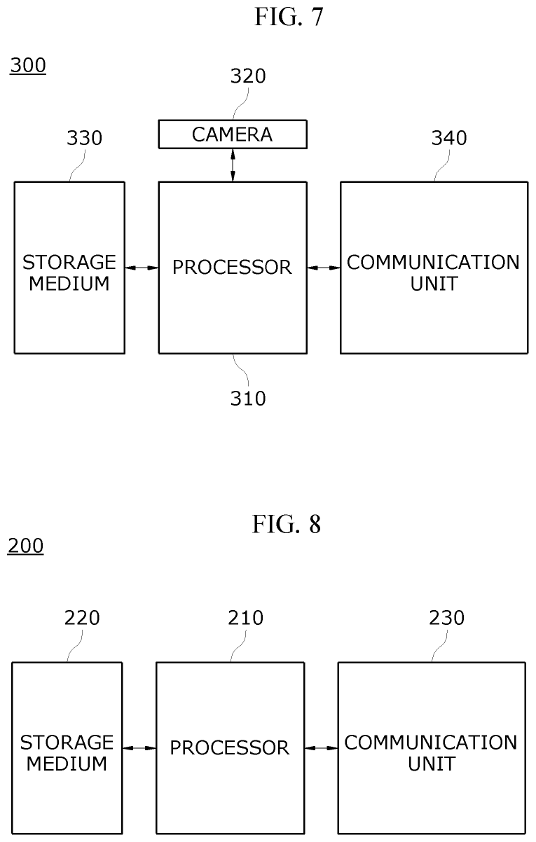

FIG. 7 is a block diagram illustrating an internal configuration of an IoT device 300 according to an embodiment of the present invention.

Referring to FIG. 7, the IoT device 300 may be a computing device. The computing device may be, for example, an IP camera device having a communication function and a photographing function.

The IoT device 300 may include a processor 310, a camera 320, a storage medium 330, and a communication unit 340.

The processor 310 may control operations of the peripheral elements 320 to 340.

Moreover, the processor 310 may have a data processing function and may perform an encryption/decryption process on data, a communication message, and information each transmitted and received through the communication unit 340 on the basis of the data processing function.

For example, the processor 310 may perform a processing process of decrypting encrypted information (including encrypted user authentication information, encrypted security state information, and encrypted command information) received from a user device 100 by using a key value Ki received from an escrow server 200.

Moreover, the processor 310 may process intermediate data or resultant data generated by one of the peripheral elements 320 to 340 to generate processed data and may transfer the generated data to one other element.

In order to control data processing and operations of the peripheral elements 320 to 340, the processor 310 may be implemented as a controller, an arithmetic logic unit (ALU), a digital signal processor, a microcomputer, a field programmable gate array (FPGA), a programmable logic unit (PLU), a microprocessor, or a hardware module for executing and responding to an instruction.

The camera 320 may be referred to as an IP camera. The camera 320 may photograph a peripheral region in response to an encrypted command from the user device 100 to obtain a photograph image.

Here, the encrypted command from the user device 100 may be a command encrypted based on a key value Ki generated based on a reliability level of the user device 100 determined by the escrow server 200.

The storage medium 330 may include a volatile storage medium and a non-volatile storage medium. The storage medium 330 may be implemented as, for example, a volatile memory, a non-volatile memory, a hard disk, or the like.

The storage medium 330 may temporarily or permanently store key list information including a key value Ki and a key ID each received from the escrow server 200 on the basis of control by the processor 310. The key list information stored in the storage medium 330 may be periodically updated.

Moreover, the storage medium 330 may temporarily or permanently store key list information including a user ID, a key value Ki and a key ID each received from the escrow server 200.

The communication unit 340 may support wireless communication between the escrow server 200 and the user device 100 on the basis of control by the processor 310. The wireless communication may include wireless Internet communication, mobile communication (for example, 3G, 4G, and 5G communications), etc. In order to support the wireless communication, the communication unit 340 may include a plurality of hardware modules having a modulation function, a demodulation function, a filtering function, and an amplification function.

FIG. 8 is a block diagram illustrating an internal configuration of an escrow server 200 according to an embodiment of the present invention.

Referring to FIG. 8, the escrow server 200 may include a processor 210, a storage medium 220, and a communication unit 230.

The processor 210 may control operations of the peripheral elements 220 and 230.

The processor 210 may have a data processing function.

Moreover, the processor 210 may process intermediate data or resultant data generated by one of the peripheral elements 220 and 230 to generate processed data and may transfer the generated data to one other element.

In order to control data processing and operations of the peripheral elements 220 and 230, the processor 210 may be implemented as a controller, an arithmetic logic unit (ALU), a digital signal processor, a microcomputer, a field programmable gate array (FPGA), a programmable logic unit (PLU), a microprocessor, or a hardware module for executing and responding to an instruction.

The communication unit 230 may support wireless communication between the escrow server 200 and a user device 100. Also, the communication unit 230 may support wireless communication between the escrow server 200 and an IP camera device 300.

In order to support the wireless communication, the communication unit 230 may include a plurality of hardware modules having a modulation function, a demodulation function, a filtering function, and an amplification function.

The processor 210 may control the communication unit 230 to receive an access request message from the user device 100.

The processor 210 may control the communication unit 230 to generate a secure channel between the escrow server 200 and the user device 100. Also, the processor 210 may control the communication unit 230 to generate a secure channel between the escrow server 200 and an IoT device 300.

The processor 210 may determine a reliability level of the user device 100 on the basis of security state information received from the user device 100, generate a key value Ki corresponding to the determined reliability level and a key ID of the key value Ki, and control the communication unit 230 to provide the generated key value Ki and key ID to the user device 100.

The processor 210 may control the communication unit 230 to provide the IoT device 300 with a list including a key value Ki and a key ID bound to each other.

The processor 210 may control the communication unit 230 to provide the IoT device 300 with a list including a user ID, a key value Ki, and a key ID bound to one another.

The processor 210 may periodically update the list including the key value Ki and the key ID bound to each other or the list including the user ID, the key value Ki, and the key ID bound to one another.

The processor 210 may update the list by correcting a connection relationship between a key value Ki and a key ID and may control the communication unit 230 to provide an updated list to the IoT device 300.

According to the embodiments of the present invention, only a user device having an access authority may access an IoT device to receive various information (for example, image information). Also, when a user device having an access authority has a previous key, the user device may not access an IoT device. Also, when a reliability level of a user device is low, the user device may be limited in using all services provided by an IoT device (for example, an IP camera device). Accordingly, information provided by an IoT device (for example, an IP camera device) may be prevented from being leaked to the outside, and although information is leaked, only limited information may be leaked, thereby minimizing damage caused by leakage of information.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for security of an Internet of things (IoT) device, the method comprising:
transmitting, by a server, a key value determined based on a reliability level of a user device and a key identification (ID) of the key value to the user device;
encrypting, by the user device, a command representing a service requested by a user by using the key value and transmitting the encrypted command and the key ID to the IoT device; and
extracting, by the IoT device, the key value corresponding to the key ID received from the user device from pre-stored key list information, decrypting the encrypted command by using the extracted key value, executing the decrypted command to generate information requested by the user, encrypting the generated information by using the extracted key value, and transmitting the encrypted information to the user device.

2. The method of claim 1, wherein the transmitting of the key information comprises:
receiving security state information from the user device;
determining the reliability level on the basis of the security state information; and
transmitting the key information, including a key value corresponding to the determined reliability level and a key ID of the key value, to the user device.

3. The method of claim 1, wherein the security state information about the user device comprises at least one of version information about an operating system installed in the user device and version information about a security patch installed in the user device.

4. The method of claim 1, further comprising, before the transmitting of the key value and the key ID to the user device, transmitting, by the server, the key list information to the IoT device,
wherein the transmitting of the key list information further comprises periodically updating the key list information about where a plurality of key IDs are respectively connected to a plurality of key values.

5. The method of claim 4, wherein the updating comprises correcting a connection relationship between the plurality of key IDs and the plurality of key values.

6. The method of claim 1, wherein the encrypted command comprises a command encrypted based on different key values determined based on first to third reliability levels.

7. A server for security of an Internet of things (IoT) device, the server comprising:
a processor configured to generate a key value determined based on a reliability level of a user device and a key identification (ID) of the key value; and
a communication unit configured to, based on control by the processor, transmit the key value and the key ID to the user device so that the user device encrypts a command representing a service requested by a user by using the key value and the key ID each determined based on a reliability level thereof and transmits the encrypted command to the IoT device.

8. The server of claim 7, wherein the processor determines the reliability level of the user device on the basis of security state information received from the user device through the communication unit.

9. The server of claim 8, wherein the security state information comprises version information about an operating system installed in the user device and version information about a security patch installed in the user device.

10. The server of claim 7, wherein the communication unit transmits, to the IoT device, key list information about where a plurality of key IDs are respectively connected to a plurality of key values, based on control by the processor.

11. The server of claim 10, wherein the communication unit transmits periodically-updated key list information to the IoT device on the basis of control by the processor.

12. The server of claim 10, wherein the processor corrects a connection relationship between the plurality of key IDs and the plurality of key values to periodically update the key list information and transmits the updated key list information to the IoT device through the communication unit.

13. An Internet of things (IoT) device comprising:
a communication unit configured to receive a command, encrypted by using a key value determined based on a reliability level of a user device, and a key identification (ID) of the key value from the user device;
a storage medium configured to store key list information about where a plurality of key IDs are respectively connected to a plurality of key values; and
a processor configured to extract the key value, connected to the key ID received through the communication unit, from the key list information, decrypt the encrypted command by using the extracted key value, execute the decrypted command to generate information, encrypt the generated information by using the extracted key value, and transmit the encrypted information to the user device through the communication unit.

14. The IoT device of claim 13, wherein the processor receives the key list information from a server through the communication unit and stores the received key list information in the storage medium.

15. The IoT device of claim 14, wherein the processor periodically receives key list information, obtained by correcting a connection relationship between a plurality of key IDs and a plurality of key values, from the server through the communication unit and updates the key list information, stored in the storage medium, to key list information about where the connection relationship is corrected.

16. The IoT device of claim 13, wherein the command decrypted by the processor is a kind of a user request service limited based on the reliability level of the user device.

17. The IoT device of claim 13, further comprising a camera,
wherein the processor encrypts a real-time camera image captured by the camera by using the extracted key value.

18. The IoT device of claim 17, wherein the processor encrypts the real-time camera image captured for a limited time or encrypts the real-time camera image captured without time being limited, based on the reliability level of the user device.

19. The IoT device of claim 17, wherein, when the reliability level of the user device is optimal, the processor executes the decrypted command to control zoom-in, zoom-out, and rotation of the camera.
